(19) United States
(12) Patent Application Publication
(10) Pub. No.: US 2002/0012060 A1
(43) Pub. Date: Jan. 31, 2002

(54) Variable optical filter

(76) Inventors: Martin High, Ontario (CA); Wilson High, Killarney (CA); Eleanor Samson, Winnipeg (CA); Gale Ladd, Toronto (CA); Gary Ball, Palosveres Estate (CA)

Correspondence Address: ZARLEY MCKEE THOMTE VOORHEES & SEASE PLC, SUITE 3200, 801 GRAND AVENUE, DES MOINES, IA, 50309-2721, US

(21) Appl. No.: 09/827,833

(22) Filed: Apr. 6, 2001

(30) Foreign Application Priority Data
Apr. 20, 2000 (CA) 2,306,290

(51) Int. Cl. H04N 5/33

(52) U.S. Cl. 348/342; 348/168

(57) ABSTRACT

A variable optical filter for video cameras designed to variably attenuate certain wave length signals by means of alternating radially oriented areas of coatings which are opaque or partially opaque to the aforesaid wave lengths. A pair of similarly designed filters can be relatively rotated to cause opaque areas to overlap non-opaque areas and thereby reduce the signal intensity.

This invention relates to improvements in the optical imaging. In particular, it relates to a variable filter for video cameras of the type which sense wave lengths used by “heads up” imaging systems employed to assist pilots in modern aircraft when landing in poor visibility such as fog.

The invention is not limited to aviation purposes and may be used for any system which requires a light or radiation signal to be attenuated in a variable way for optical purposes. However, aircraft landing systems are a particularly useful application of the present invention and are described herein to illustrate the advantages of the present invention.

Modern aircraft typically have highly sophisticated imaging systems which project onto the windshield of the aircraft an image of the airport runway which is being approached. These systems are most important in conditions of poor visibility such as fog, rain or snow and are intended to give the pilot a virtual picture of the airport approach lights or beacons and an image of the runway itself.

This imaging is provided by a video camera designed to read wave length transmissions in the lower end of infrared range, specifically in the 1 to 5 micron wave length region.

The system is somewhat complicated because it requires that the camera read or sense two separate signal bands and create two sets of superimposed images.

First of all, because of the design characteristics and the protective glass covering, the beacons will emit (in addition to the visual light) infrared signals in the range of approximately 1 to 2.5 microns.

Secondly, the hard surface (tarmac) of the runway itself will emit a thermal radiation in the range of approximately 3 to 5 microns.

It should be realized that light and other radiation in different wave bands is also emitted but the range of 1 to 5 microns is especially significant in aircraft use because these transmissions are transparent to atmospheric conditions such as fog, etc. Furthermore, for purposes of this illustration, the two wave bands, 1-2.5 and 3-5 microns respectively, are significant because those are the separate wave bands which are the aircraft infrared imaging camera are designed to monitor.

It will be appreciated that as an aircraft approaches an airport from a great distance it is the intensity of the beacon lights which will be picked up first to guide the aircraft on the proper course to the proper location of the airport and for this purpose the camera must have maximum sensivity to the 1 to 2.5 micron wave band.

However, as the plane approaches the runway, the pilot will wish to concentrate on the image of the runway itself rather than the beacon lights and this is especially important just before touch down and immediately after landing.

The problem that arises is that the camera which must be sensitive to light beacons at a great distance generates an image which becomes far too bright and intensive as the aircraft gets closer to the light beacon and this extremely strong signal tends to cause saturation of the individual pixels in the imaging system which results in “blooming” or overflow lighting which obscures and washes out the image of the runway which is created by the thermal emissions in the 3 to 5 micron range. It is therefore necessary to modify the intensity of the signal received from the beacon lights in the 1 to 2.5 micron range, without affecting the image of the runway as the plane approaches touch down.

It is therefore the purpose of this invention to provide an improved filter for a camera capable of attenuating the strength of the radiation signal transmitted to the camera automatically.

It is also the purpose of this invention to provide an improved filter capable of attenuating part of the signal received by a camera without affecting the remainder of the received signal.

It is also the purpose of this invention to provide a means for adjusting the intensity of the signal, or part of a signal in a manner which is smooth, seamless and uninterrupted.

It is also the purpose of this invention to provide a filter which will vary the intensity of infrared light in the range of approximately 1 to 2.5 microns without interfering with thermal radiation in the range of 3 to 5 microns range.

It is also the purpose of this invention to provide means whereby the intensity of the signal may be varied automatically by feedback based on the signals intensity without requiring the attention of an operator or the pilot of an aircraft to be distracted from other landing operations.

These objects and other advantages are sought to be achieved by the present invention which provides a filter placed in front of the camera lens designed to receive infrared signals. The filter will transmit thermal emissions in the 3 to 5 micron wave lengths range while blocking or partially blocking light signals in the 1 to 2.5 micron range.

To achieve this the present invention provides a pair of discs adjacent to each other and axially aligned, both of which have similar patterns of areas in which each defined area has one of two alternate light transmitting characteristics. One set of areas is transparent in the 1 to 5 micron range (hereinafter referred to as the “transparent area” for simplicity”). The other is transparent to the 3 to 5 micron wave lengths but opaque or partially opaque to the 1 to 2.5 micron range (hereinafter referred to as the “opaque area” for simplicity).

On each of the aforementioned pair of discs, these areas are located alternately one adjacent to the other so that by moving one disc relative to the other the opaque areas may be aligned or may be partially or fully overlapped with the transparent areas to cause a transmissibility of the 1 to 2.5 micron signals. In the preferred embodiment the alternate areas are radially extending pie shaped sections.

In the preferred embodiment automatic means, preferably in the nature of an electric motor electronically controlled and geared to one of the discs will allow one disc to be rotated relative to the other disc so that the alternating patterns may be moved to a position in which the opaque sections overlap each other to a position in which the opaque sections on one disc partially or completely overlap the transparent sections of the other disc. Ideally, the automatic means is controlled by electronic feedback which measures when the pixels of the image created by the camera are saturated with light and will cause the electric motor to rotate the discs so that the transparent sections of one disc are partially blocked by opaque sections of the other disc so as to decrease the strength of the signal received in the 1 to 2.5 micron range.

The automatic control means is preferably controlled by measuring the intensity of the light in the image created by the camera in response to the 1 to 2.5 micron light. This can be accomplished by setting the control mechanism system so that when the degree of light created by the beacons saturates the axles of the image and begins to bloom or overflow into other regions, the control mechanism will be activated to increase the overlap by which the opaque section of one disc will overlap the transparent section of the other disc and reduce the intensity of the 1 to 2.5 micron signal.

This invention may be better understood by a detailed description of a preferred embodiment thereof with reference to the attached drawings in which:

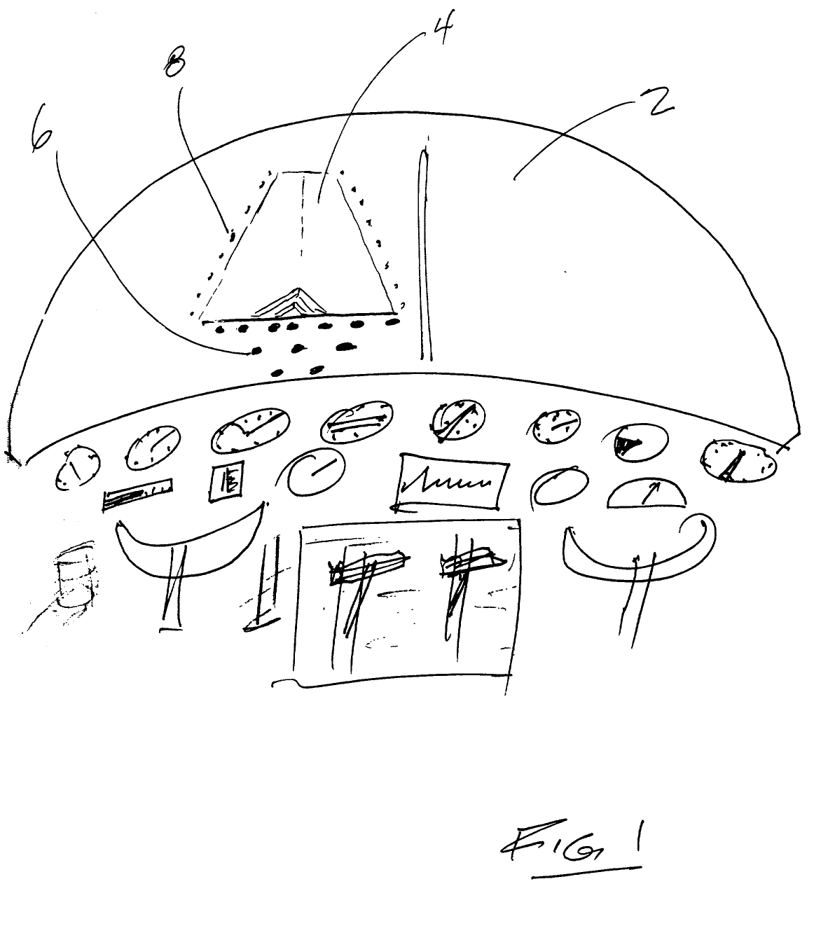

FIG. 1 is a simplified illustration of the aircraft cockpit with a “heads up” image of a runway projected on the windshield;

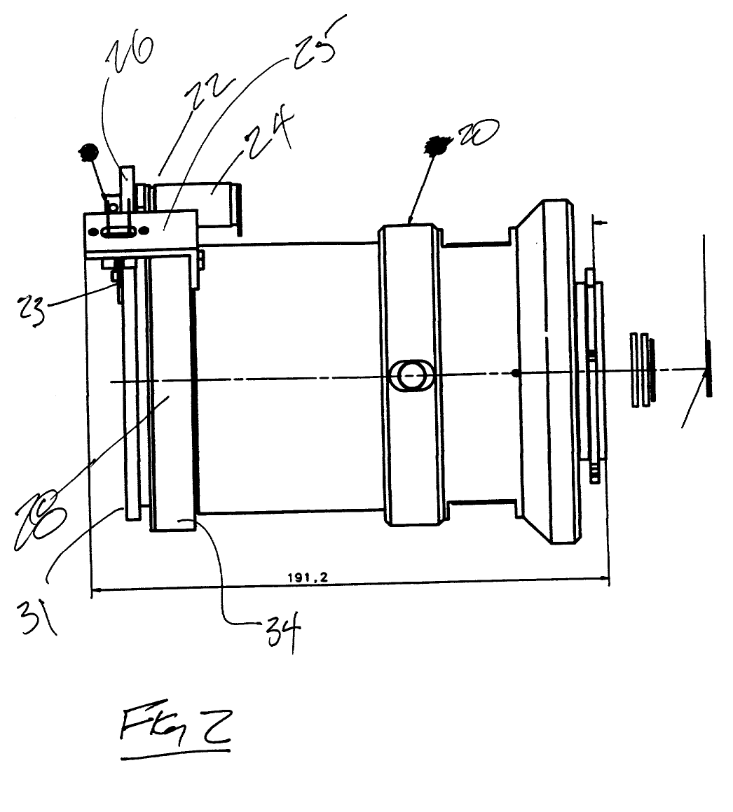

FIG. 2 is an elevation view of a camera used to create the “heads up” image referred to in FIG. 1;

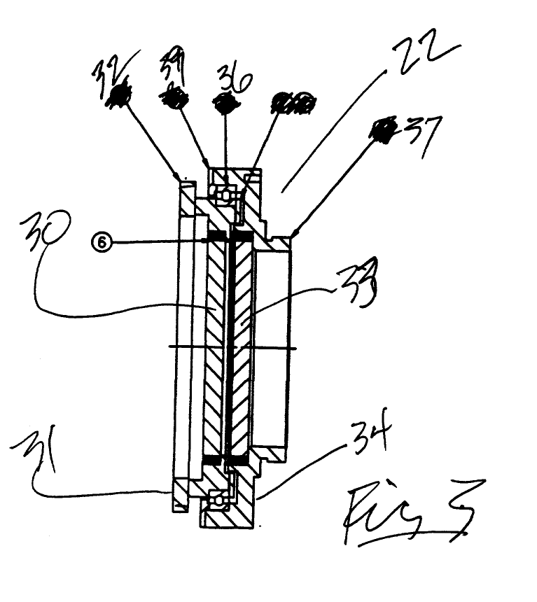

FIG. 3 is a vertical cross-section of the filter assembly shown in FIG. 2;

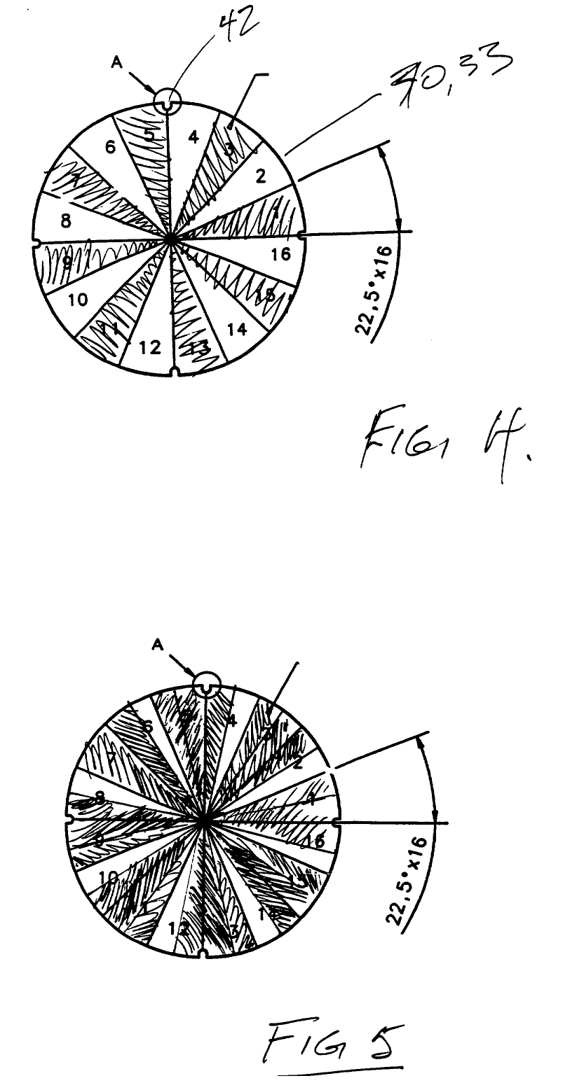

FIG. 4 is a schematic illustration of the areas of different transparency of the filter disc shown in FIG. 3; and

FIG. 5 is a schematic illustration of a pair of discs as illustrated in FIG. 4.

As previously mentioned, this invention is designed for the general purpose of attenuating signals to an infrared imaging device or other optical camera. However, it is especially applicable to enhance the “heads up” imaging system provided on modern aircraft, and is therefore illustrated in that context in the following description of a preferred embodiment.

FIG. 1 is a simplistic illustration of an aircraft cockpit showing a “heads up” image in an airport runway projected on the windshield 2, the image comprising a runway 4 having approach beacon lights 6 and runway lights 8 outlining the location of the runway.

This visual illustration is provided to a pilot in conditions of poor visibility such as darkness, rain, fog, or snow and allows the pilot to approach the runway as if he could see it. The image presented is constantly changing like a television image and is projected on the windscreen by means of a projector and a camera, the lens of which is 20 illustrated in FIG. 2, the details of which are not described herein as the technology is well known to those skilled in the art and the equipment is readily available. It is sufficient to note that the camera is designed to read transmissions in the 1 to 5 micron wave length range which include transmission from the beacon lights in the 1 to 2.5 micron range and thermal transmissions from the runway in the 3 to 5 micron range because these transmissions are both available from the image source and are readily transmitted and received in adverse atmospheric conditions as mentioned above.

However, in accordance with the present invention the illustrated camera has, in front of the lens 20, a filter assembly illustrated at 22 which comprises an electric motor 24, a drive gear 26 and a filter mount 28, all of which are axially aligned and mounted to the front of the camera lens 20.

The details of the filter assembly are illustrated by the cross-section drawing in FIG. 3 in which a first filter disc 30 is mounted within a support ring 31 having on its outer rim a spur gear 32 designed to cooperate with the drive gear 26 of the motor 24 for purposes which will be described in more detail later.

A second filter disc 33 is mounted in a second support ring 34 which also supports the first support ring 31 by means of a radial ball bearing assembly 36 and circular flange 39 which allow the two rings to rotate angularly relative to each other while remaining in the same parallel, adjacent location and axial alignment.

The inner end 37 of the second support ring 34 is provided with attachment means (such as conventional male or female threads) which allow the filter assembly to be mounted to the forward end of the camera lens 20.

It will be realized that although the first disc and ring 31 are free to rotate relative to the second disc and ring 34, this relative position is controlled by virtue of the fact that the motor 24 is mounted on the disc 34 and the gear 26 attached to the motor is meshed with the gear 32 on the outer rim of the disc 31. Therefore, the relative angular rotation of the two discs with respect to each other is restricted and controlled by the activation of the motor 24.

FIG. 4 illustrates one of the discs illustrated in FIG. 3, both of which are substantially identical. Each filter disc has at least one and preferably more recesses such as illustrated at 4297Xf in FIG. 4, which are designed to receive corresponding pines mounted in the respective rings 31 and 34 so as to maintain the discs in six rotational orientation within the respective rings and relative to each other.

For optical purposes the disc are preferably made of silicon, (although certain other materials may be substituted) chosen for its transmissibility of wave lengths in the 1 to 5 micron range and are coated on both sides by a high efficiency anti-reflective coating (known in the industry and referred to as “HEAR” coating) which allows transmission of the desirable signal and overcomes the inherent tendency of silicon to be reflective.

The other side of the discs are differentially coated in the areas outlined and identified by numbers which appear on the drawing of FIG. 4 for illustrative purposes only and do not appear on the discs themselves. In the preferred embodiment the areas are radially extending pieshaped sections and each of these sixteen air sections cover an area of 22½° of arc. Although the arc is not necessarily as shown, this figure and the size of the segments are preferably related to the optical characteristics of the camera. In the illustrated embodiment, this arc represents a maximum width of less than 16 mm and is therefore suitable to a camera which has a pupil aperture of 25 mm and an F number 1.3 segments with a peripheral dimension of no more than 16 mm will ensure that all signals from the field of view will be received in the camera without omission or distortion.

Each of the illustrated sections is treated differently than the next adjacent section in alternating fashion so that, for instance, the even numbered fields are coated to transmit radiation in the range of 1 to 5 microns (herein referred to as “the transparent sections”) while the adjacent alternating odd numbered fields are coated to block, or partially suppress, transmission in the 1 to 2.5 micron range (hereinafter referred to as “the opaque sections”).

It will be apparent that when the two similar discs 30 and 33 are oriented so that the opaque areas are aligned, the maximum amount of light or radiation transmission in the 1.5 micron range will be transmitted to the camera. When the filter is in this “open” position with no overlap between the opaque and transparent areas, and the aircraft using such a device is at a great distance from the air port, the beacon light transmission in the 1 to 2.5 micron range will be received at maximum intensity by the camera and brightly illustrated on the screen. At this point the image of the runway will be relatively insignificant.

As the plane approaches the runway the intensity of the two images will brighten to a point where the beacons will become too intense and cause blooming or spreading of the light image to the extent that it dominates or obscures the image of the runway, which image becomes more important as the pilot gets closer to landing.

By means of a feedback device, the camera senses the point when an individual pixel or a group of pixel becomes “saturated” meaning that it is at its maximum signal intensity and therefore no longer respond to variations in signal strength and tends to obscure other less intense images. At this point the feedback system activates the electric motor 24 rotating the gears so that one of the discs is rotated relative to the other causing an opaque area in one disc to overlap a transparent area in the other disc. Since the opaque design is designed to block the 1 to 2.5 micron radiation, this overlap will diminish the strength of the signal emanating from the beacon without impairing the signal which generates the image of the runway itself.

At some point depending on the settings programmed into the controller, the entire circle of the filters may be covered with opaque areas so that all or most of the light from the beacons is suppressed and only the image of the runway is projected. Alternatively, the controller may be set so that the entire area of the filter is never covered by the opaque segment and some signal from the beacons will always be transmitted but at lesser intensity.

While it may be possible to attenuate the beacon light signal by means of a series of separate filters, each designed to successively reduce the amount of the light transmitted 1 to 2.5 micron radiation. This causes the image to jump or blink each time the device shifts from one filter to the next and creates an uneven and distracting image to the pilot. Another alternative is to use a form of iris design to gradually reduce the radius of the transmitting section of the filter to adjust the intensity, but this has the undesirable result that it restricts the entire range of wave lengths instead of a selected wave band.

On the other hand, the gradual relative rotation of the pieshaped segments described in the illustrated embodiment allows a constant, linear, gradation in the transparent area of the filter without interruption or irregularity in the transmission. This arrangement also uses the entire area of the filter in relatively equal proportions.

It will, or course, be appreciated that the gradual reduction of the transparent area may be created by other patterns such as alternating squares or rectangles, etc., but the conventional circular shape of a camera lens makes the use of a circular filter of the present invention appropriate. Even in the context of the circular configuration other shapes for the respective transparent and opaque areas may be chosen such as a spiral configuration or other shapes which extend from the centre to the periphery of the filter in a pattern which is not necessarily parallel to a radial line, although such patterns are more difficult to apply than the illustrated pattern of the preferred embodiment.

Development of the present invention has taught that coated areas such those described sometimes have small channels of transmission which distort the signal and it may for matters of quality be advisable to coat the discs on two sides so that such areas of channelling are offset and therefore nullified by the two opposite coatings on the opposite sides of a disc.

The inventors have also discovered that this device is more easily installed and adjusted if a photo interrupter 23 is positioned and adjacent to the movable disc support ring 31 and held by a support arm 25 mounted to the stationary disc ring 34. This device allows the operator or technician to establish a “zero” position or to calibrate the degree of overlap between the coated areas of the respective discs.

It has also been discovered that coating parts of the filter and not others creates a difference in thickness which can cause some interference with light or radiation transmission and it is therefore considered advisable to treat the non-opaque areas with additional HEAR coatings to establish an even surface on the filter disc.

It will, of course, be realized that other modifications and variations of the illustrated embodiment may be employed without departing from the inventive concept herein.

1. A variable filter for a video camera comprising:
a first filter disc having a pattern of areas coated to be at least partially opaque to transmission of electric wave length and a pattern of adjacent areas without said coating;
a second filter disc having a similar pattern of opaque areas and non-opaque areas;
means to rotate at least one of said discs relative to the other said disc between a position in which said opaque areas are lined and positioned where opaque areas on one disc align at least partially with non-opaque areas on the other disc;
whereby the transmission of signals to the camera may be attenuated.

2. A variable filter as claimed in claim 1 in which said patterns consist of pie-shaped areas extending radially from the centre of said discs.

3. Apparatus as claimed in claims 1 or 2 in which the means to rotate one disc relative to the other disc comprises a gear attached to said one disc activated by a drive gear connected to an electric motor.

4. Apparatus as claimed in claims 1, 2 or 3 in which the rotation of one disc relative to the other is controlled by a signal responsive to the intensity of the radiation transmitted through said filter.
